(19) United States
(12) Patent Application Publication
(10) Pub. No.: US 2025/0326151 A1
(43) Pub. Date: Oct. 23, 2025

(54) CUTTING DEVICE AND METHOD

(71) Applicant: HEMA (CHINA) CO., LTD., Shanghai (CN)

(72) Inventors: Qiang Cao, Shanghai (CN); Chunqiu Liu, Chengdu (CN); Huixiong Lin; Xianyong Jin

(73) Assignee: HEMA (CHINA) CO., LTD., Shanghai (CN)

(21) Appl. No.: 18/704,719

(22) PCT Filed: Nov. 11, 2022
(86) PCT No.: PCT/CN2022/131526

§ 371 Date: Apr. 25, 2024

(30) Foreign Application Priority Data
Nov. 17, 2021 (CN) 202111363993.5

(51) Int. Cl. B26D 7/06; B26D 1/06; B26D 7/30

(52) U.S. Cl. CPC B26D 7/0625; B26D 1/06; B26D 7/30

(57) ABSTRACT

A cutting device and method. The cutting device comprises a frame body (1), provided with: a conveying assembly (2), the conveying assembly comprising a feeding end (21), a discharging end (22), and an avoidance position (23) provided between the feeding end and the discharging end, and the conveying assembly being constructed to convey a material (5) from the feeding end to the discharging end; and a cutting assembly (3), the cutting assembly comprising a cutter (31), and the cutter being constructed to be capable of moving towards the conveying assembly to the avoidance position.

The present application is a national stage filing under 35 U.S.C. 371 of International Patent Application Serial No. PCT/CN2022/131526, filed Nov. 11, 2022, entitled “CUTTING DEVICE AND METHOD”, which claims priority to Chinese patent application No. 202111363993.5, filed with the China Patent Office on Nov. 17, 2021 and entitled “CUTTING DEVICE AND METHOD”. The entire contents of these applications are incorporated herein by reference in their entirety.

### TECHNICAL FIELD

The present disclosure relates to the field of industrial processing equipment, and specifically to a cutting device and method.

### BACKGROUND

Fresh-cut vegetables are fresh vegetables washed and then cut into desired shapes such as strips, slices, and chunks, with some directly edible, and some ready for cooking. Fresh-cut vegetables are favored by consumers and paid attention to by institutions due to the nature, freshness, safety, hygiene, convenience, environmental protection and other characteristics.

### SUMMARY

The present disclosure provides a cutting device and method.

A first aspect of the present disclosure provides a cutting device, including a frame body, wherein the frame body is provided with:
a conveying assembly, the conveying assembly including a feeding end, a discharging end, and an avoidance position provided between the feeding end and the discharging end, and the conveying assembly being constructed to convey a material from the feeding end to the discharging end; and
a cutting assembly, the cutting assembly including a cutter, and the cutter being constructed to be capable of moving towards the conveying assembly to the avoidance position.

In an embodiment of the present disclosure, the conveying assembly includes a bearing surface for bearing the material, and the avoidance position is constructed as a groove-shaped structure lower than the bearing surface.

In an embodiment of the present disclosure, the conveying assembly includes:
a conveyor belt, the conveyor belt being bent to form the avoidance position;
a first limit roller, the first limit roller being provided on both sides of an opening of the avoidance position and located on an inner side of the conveyor belt; and
a second limit roller, the second limit roller being provided at a groove bottom of the avoidance position and located on an outer side of the conveyor belt.

In an embodiment of the present disclosure, the conveying assembly further includes a plurality of transmission rollers provided on the inner side of the conveyor belt, and a first driving mechanism for driving the conveyor belt to rotate through the transmission rollers.

In an embodiment of the present disclosure, the cutting assembly further includes a cutter holder connected to the frame body, the cutter being guided to fit on the cutter holder.

In an embodiment of the present disclosure, the cutter holder is provided as a door-shaped structure, two sides of the cutter holder are respectively provided with rails, and the cutter is guided to fit with the rails on the two sides.

In an embodiment of the present disclosure, the cutting assembly further includes a transmission mechanism and a second driving mechanism, the second driving mechanism driving the cutter to move through the transmission mechanism.

In an embodiment of the present disclosure, the transmission mechanism includes: a transmission shaft, a first cam and a second cam fixedly connected to two ends of the transmission shaft respectively, and further includes a first connecting rod and a second connecting rod;
one end of the first connecting rod being connected to the first cam, and the other end of the first connecting rod being connected to the cutter;
one end of the second connecting rod being connected to the second cam, and the other end of the second connecting rod being connected to the cutter; and
the transmission shaft being configured to drive the first connecting rod and the second connecting rod to move synchronously through the first cam and the second cam, thereby driving the cutter to move.

In an embodiment of the present disclosure, the first cam and the first connecting rod are provided on one side of the conveying assembly, and the second cam and the second connecting rod are provided on the other side of the conveying assembly; and the first connecting rod is connected to one end of the cutter, and the second connecting rod is connected to the other end of the cutter.

In an embodiment of the present disclosure, the frame body is further provided with baffles, the baffles are provided on two opposite sides of the conveying assembly; and the baffles on two sides are inclined to form a flare on the two sides of the conveying assembly.

In an embodiment of the present disclosure, the frame body is further provided with a guide assembly, the guide assembly being configured to be provided along an extension direction of the conveying assembly for guiding the material on the conveying assembly.

In an embodiment of the present disclosure, the guide assembly includes a plurality of guide rollers, a plurality of the guide rollers having a rotation axis perpendicular to the extension direction of the conveying assembly.

In an embodiment of the present disclosure, the guide rollers include fixed guide rollers, the fixed guide rollers being arrayed along at least one side of the conveying assembly.

In an embodiment of the present disclosure, the guide rollers include an inclined guide roller, the inclined guide roller being provided at least on one side of the conveying assembly, and the inclined guide roller being provided inclinedly in such a manner that an upper end is gradually close to the conveying assembly.

In an embodiment of the present disclosure, the frame body is further provided with a protective cover, the protective cover being covered outside the cutting assembly and leaving an opening for the material to enter and exit.

In an embodiment of the present disclosure, the cutting device further includes a control system, the control system being configured to control on/off and movement speeds of the conveying assembly and the cutting assembly.

In an embodiment of the present disclosure, the cutting device further includes:
a weighing unit, the weighing unit being configured to acquire weight data T of the material; and
a measuring unit, the measuring unit being configured to at least acquire length data L of the material.

In an embodiment of the present disclosure, the measuring unit is configured to acquire profile data of the material, the profile data including length data L and radial dimension data of the material.

In an embodiment of the present disclosure, the cutting device includes an information collection position provided in front of the feeding end of the conveying assembly, and the weighing unit and the measuring unit are provided at the information collection position.

In an embodiment of the present disclosure, the control system is configured to: perform calculation according to a preset algorithm based on the weight data T, the length data L, and a single target standard weight T′ and a correction factor preset for the material, to obtain a single target length L′ for cutting the material, and adjust, based on the single target length L′, a relative movement speed of the conveying assembly and the cutting assembly.

In an embodiment of the present disclosure, the cutting device further includes a control panel electrically or communicatively connected to the control system;
the control panel being configured to display an actual length of a finished product cut by the cutting assembly, and to be capable of setting a single target standard weight T′ for the material.

A second aspect of the present disclosure provides a cutting method, employing the above cutting device, including:
acquiring weight data T and length data L of a material;
performing calculation through a preset algorithm based on a preset single target standard weight T′ and a correction factor, the weight data T, and the length data L, to obtain a single target length L′; and
sending the single target length L′ to the cutting device, and controlling the cutting device to cut the material into a finished product having a length of the single target length L′.

In an embodiment of the present disclosure, the correction factor includes a quantity correction factor X, the quantity correction factor X being a quantity of finished products that allows for loss of the material; and
the performing calculation through a preset algorithm based on a preset single target standard weight T′ and a correction factor, the weight data T, and the length data L, to obtain a single target length L′ includes:
determining a weight ratio based on the preset single target standard weight T′ and the weight data T;
determining a correction difference based on the weight ratio and the quantity correction factor X; and
obtaining the single target length L′ based on the correction difference and the length data L.

In an embodiment of the present disclosure, profile data of the material is obtained, the profile data including radial dimension data of the material.

In an embodiment of the present disclosure, the correction factor includes a quantity correction factor X and a length correction factor Y, the quantity correction factor X being a quantity of finished products that allows for loss of the material, and the length correction factor Y being negatively correlated with a radial dimension of the profile data of the material; and
correspondingly, the performing calculation through a preset algorithm based on a preset single target standard weight T′ and a correction factor, the weight data T, and the length data L, to obtain a single target length L′ includes:
determining a weight ratio based on the preset single target standard weight T′ and the weight data T;
determining a correction difference based on the weight ratio and the quantity correction factor X;
determining a correction ratio based on the correction difference and the length data L; and
obtaining a single target length L′ based on the correction ratio and the length correction factor Y.

In an embodiment of the present disclosure, the controlling the cutting device to cut the material into a finished product having a length of the single target length L′ includes:
controlling the cutting device to adjust a relative movement speed of a conveying assembly and a cutting assembly according to the single target length L′, so that the cutting assembly cuts, based on the relative movement speed, the material into a finished product having a length of the single target length L′.

Other features of the present disclosure and advantages thereof will become apparent through the following detailed description of exemplary embodiments of the present disclosure with reference to the drawings.

### BRIEF DESCRIPTION OF THE DRAWINGS

The drawings, which are incorporated in and constitute a part of the specification, illustrate embodiments of the present disclosure and, together with the description thereof, serve to explain the principles of the present disclosure.

FIG. 1 is a schematic diagram of an overall structure of a cutting device provided in an embodiment of the present disclosure;

FIG. 2 is a schematic structural diagram of a conveying assembly and a cutting assembly of a cutting device provided in an embodiment of the present disclosure;

FIG. 3 is a schematic diagram of a partial structure of a conveying assembly of a cutting device provided in an embodiment of the present disclosure;

FIG. 4 is a schematic structural diagram of a cutting device with a protective cover removed provided in an embodiment of the present disclosure;

FIG. 5 is a schematic diagram of an information collection position provided in an embodiment of the present disclosure; and

FIG. 6 is a flow chart of a cutting method provided in an embodiment of the present disclosure.

### DETAILED DESCRIPTION

Various exemplary embodiments of the present disclosure will now be described in detail with reference to the drawings. It should be noted that the relative arrangement of components and steps, numerical expressions, and numerical values set forth in these embodiments do not limit the scope of the present disclosure, unless otherwise specified.

The following description of at least one exemplary embodiment is merely illustrative in nature and in no way serves as a limitation on the present disclosure or its application or use.

Techniques, methods, and apparatuses known to those of ordinary skill in the relevant field may not be discussed in detail, but where appropriate, the techniques, methods, and apparatuses should be regarded as part of the specification.

In all of the examples shown and discussed herein, any specific value should be construed merely as an example, rather than a limitation. As such, other examples of exemplary embodiments may have different values.

It should be noted that like reference numerals and letters refer to like items in the following drawings, and thus, once a certain item is defined in one drawing, it need not be further discussed in subsequent drawings.

Herein, “above”, “below”, “front”, “rear”, “left”, “right” or the like are only used to indicate a relative positional relationship between relevant parts, rather than limiting the positions of these relevant parts.

Herein, “first”, “second” or the like are only used to distinguish each other, rather than indicating the importance and order, and the premise of mutual existence.

Herein, “equal”, “same” or the like are not limitations in a strict mathematical and/or geometric sense, but also include errors that can be understood by those skilled in the art and allowed in manufacture or use.

At present, wax gourds are mostly processed by employing the way of manual cutting with knives. The manual processing way is low in processing efficiency, poor in precision, and prone to overcutting or undercutting to produce waste products, resulting in high overall loss. As such, there is an urgent need for a solution to solve the problems of yield and processing efficiency in the existing wax gourd processing.

The present disclosure provides a cutting device, which may be applied to fresh product processing and can cut fresh products into chunks, slices, strips and other shapes, such as cutting a wax gourd into multiple segments, and cutting a sweet potato into slices. The cutting device may also be used for processing other materials, such as cutting plates, tubes or the like.

The cutting device includes a frame body, the frame body is provided with a conveying assembly for conveying a material, and a cutting assembly includes a cutter and is capable of cutting the material on the conveying assembly. The conveying assembly has a feeding end and a discharging end, and the material is conveyed from the feeding end to the cutting device, and then conveyed to the discharging end after being cut.

One beneficial effect of the present disclosure lies in that the material is transported by conveying assembly, the material on the conveying assembly is cut by the cutter of the cutting assembly, and the cutter can move to the avoidance position to avoid collision with the conveying assembly; and the cutting device can replace manpower to cut and process materials, the cutting precision is high, the rejection rate is low, the labor cost is saved, and the working efficiency is high.

In the present disclosure, the specific structure and principle of the cutting device will be introduced through the following embodiments.

### First Embodiment

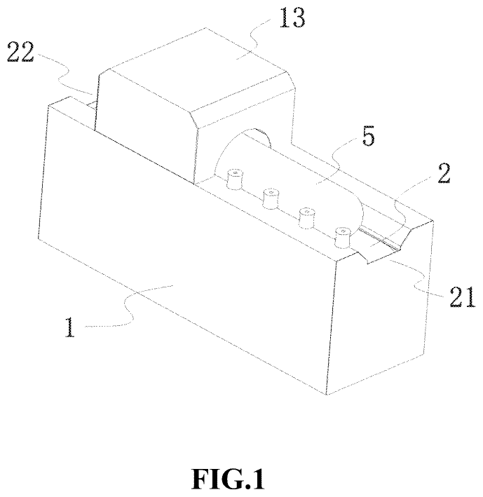

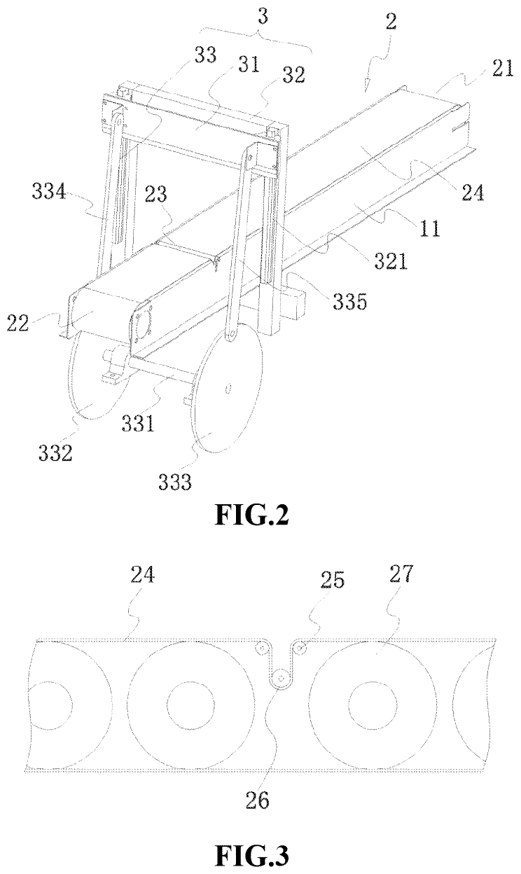

FIG. 1 is a schematic diagram of an overall structure of a cutting device provided in an embodiment of the present disclosure, and FIG. 2 is a schematic structural diagram of a conveying assembly and a cutting assembly of a cutting device provided in an embodiment of the present disclosure. As shown in FIG. 1 and FIG. 2, an avoidance position 23 is provided between a feeding end 21 and a discharging end 22 of a conveying assembly 2, and a material 5 passes through the avoidance position 23 when being conveyed on the conveying assembly 2. A cutting assembly 3 includes a cutter 31 constructed to be capable of moving towards the conveying assembly 2 to the avoidance position 23 to cut the material 5 that passes through the avoidance position 23. The avoidance position 23 can prevent the cutter 31 from directly colliding with the conveying assembly 2, and the cutter 31 can cut off the material 5 after entering the avoidance position 23.

A frame body 1 provides a mounting basis for the conveying assembly 2 and the cutting assembly 3, and the frame body 1 may be a frame structure, a table structure, a box structure or the like, to which no limitation is made in the present disclosure. In a specific implementation, as shown in FIG. 1, the frame body 1 is constructed as a box structure, and the conveying assembly 2 and the cutting assembly 3 are provided in the frame body 1 and protected by the frame body 1.

The conveying assembly 2 may be at least partially hidden inside the frame body 1, or may be completely exposed outside the frame body 1. When the conveying assembly 2 is hidden inside the frame body 1, the frame body 1 should be provided with openings at the feeding end 21 and the discharging end 23 for the material 5 to enter and exit. The conveying assembly 2 at least includes one feeding end and one discharging end, and the material can be conveyed from any feeding end to any discharging end after passing through the cutting assembly.

In an implementation, the conveying assembly 2 includes a material bearing surface for bearing the material 5. The bearing surface may be a plane or a curved surface. The avoidance position 23 is constructed as a groove-shaped structure lower than the bearing surface. The length and width of the avoidance position 23 should be greater than the length and width of the cutter 31, so that the cutter 31 can enter the avoidance position 23. The lowest position of the cutter 31 when moving should be higher than the bottom of the avoidance position 23, thereby avoiding friction or collision between the cutter 31 and an inner surface of the avoidance position 23.

FIG. 3 is a schematic diagram of a partial structure of a conveying assembly of a cutting device provided in an embodiment of the present disclosure. In an implementation, as shown in FIG. 3, the conveying assembly 2 may include a conveyor belt 24, a plurality of transmission rollers 27, and a first driving mechanism. The conveyor belt 24 may be provided in an annular structure, and the plurality of transmission rollers 27 are provided at the inner side of the conveyor belt 24 to support the conveyor belt 24 and increase the bearing capacity of the conveyor belt 24. The first driving mechanism is at least in transmission connection with one transmission roller 27, and drives the conveyor belt 24 to rotate through the transmission roller 27. With reference to the views in FIG. 2 and FIG. 3, the conveyor belt 24 is provided transversely, and an upper surface of the conveyor belt 24 moves from the feeding end 21 towards the discharging end 22. The first driving mechanism at least includes a motor, and an output end of the motor may be directly connected to the transmission roller 27, or may be in transmission connection with the transmission roller 27 through a gear, a belt or other components, to which no limitation is made in the present disclosure.

The upper surface of the conveyor belt 24 is a bearing surface, and the conveyor belt 24 is bent to form the avoidance position 23. The conveying assembly 2 further includes a first limit roller 25 and a second limit roller 26. As shown in FIG. 3, the first limit roller 25 and the second limit roller 26 define a shape of the conveyor belt 24, and the conveyor belt 24 forms the avoidance position 23 in a groove-shaped structure under the definition of the first limit roller 25 and the second limit roller 26. The avoidance position 23 may be provided in a V-shaped structure, a U-shaped structure or the like.

Specifically, the first limit roller 25 and the second limit roller 26 are perpendicular to an extension direction of the conveyor belt 24, and two ends of them may be connected to the frame body 1. The first limit roller 25 is provided at two sides of an opening of the avoidance position 23 and is located at the inner side of the conveyor belt 24; while the second limit roller 26 is provided at a bottom of the groove of the avoidance position 23 and is located at the outer side of the conveyor belt 24. With reference to the view in FIG. 3, the first limit roller 25 is attached to a lower surface of the conveyor belt 24, and the second limit roller 26 is attached to the upper surface of the conveyor belt 24.

With reference to FIG. 2, a mounting plate 11 may be provided on the frame body 1, the mounting plate 11 is located at two opposite sides of the conveyor belt 24, and the first limit roller 25, the second limit roller 26 and the plurality of transmission rollers 27 may be rotatably connected to the mounting plate 11 on a corresponding side. When two ends of the cutter 31 are beyond two sides of the conveyor belt 24, notches corresponding to the avoidance position 23 may be opened on the mounting plates 11 on the two sides, so as to avoid the cutter 31 when the cutter 31 enters the avoidance position 23.

In some implementations, the cutting assembly 3 further includes a cutter holder, and the cutter 31 is guided to fit on the cutter holder. The cutter holder may be provided as a rod-shaped structure, a door-shaped structure, a frame structure or the like, and can be connected to the cutter 31, to which no limitation is made in the present disclosure.

In an implementation, as shown in FIG. 2, the cutter holder 32 is in a door-shaped structure and includes two uprights and one cross beam. The two uprights are respectively provided on two opposite sides of the conveying assembly 2 and have bottom ends connected to the frame body 1, and the cross beam is connected between top ends of the two uprights, so that the material 5 on the conveying assembly 2 can pass through the cutter holder 32. The cutter 31 is provided transversely and may be perpendicular to the extension direction of the conveyor belt 24, or at a certain angle to the extension direction of the conveyor belt 24. The two ends of the cutter 31 are respectively guided to fit on the uprights on the two sides.

In an implementation, as shown in FIG. 2, two sides of the cutter holder 32 are respectively provided with rails 321, and the cutter 31 is guided to fit with the rails 321 on the two sides. Specifically, the cutter holder 32 is in a door-shaped structure, and the rails 321 may be respectively provided on the two uprights of the cutter holder 32. The rails 321 may employ a variety of structures. For example, the rails may be provided as a chute structure, and a slider fitting with the chute may be provided on the cutter 31; the rails may also be provided as a slide rod structure, and a slide sleeve fitting with the slide rod may be provided on the cutter 31. The above structures of the rails are only examples, and other conventional rail structures all fall within the scope of protection of the present disclosure.

In some implementations, with reference to FIG. 2, the cutting assembly 3 further includes a transmission mechanism 33 and a second driving mechanism. The transmission mechanism 33 is connected with the cutter 31, and the second driving mechanism is connected with the transmission mechanism 33, so that the second driving mechanism drives the cutter 31 to reciprocate through the transmission mechanism 33 to cut the material. The second driving mechanism may at least include a motor capable of outputting a torque. The transmission mechanism 33 includes, but is not limited to, a linkage mechanism, a gear-rack mechanism, a worm-gear mechanism, a screw mechanism, or the like. Other conventional transmission mechanisms capable of converting a rotary movement output by the motor into a linear movement also fall within the scope of protection of the present disclosure.

In an implementation, the transmission mechanism includes a cam and a connecting rod. One end of the connecting rod rotates and is eccentrically connected to the cam, and the other end of the connecting rod is hingedly connected to the cutter 31. The second driving mechanism drives the cam to rotate and drives the connecting rod to swing. Under the restriction of the rails 321 on the cutter holder 32, the connecting rod drives the cutter 31 to implement reciprocating linear movement.

In one specific embodiment, with reference to FIG. 2, the transmission mechanism 33 includes a transmission shaft 331, a first cam 332 and a second cam 333. The first cam 332 and the second cam 333 are respectively coaxially connected to two ends of the transmission shaft 331, so that the transmission shaft 331, when rotating, can drive the two cams 332, 333 to rotate synchronously. The transmission mechanism 33 further includes a first connecting rod 334 and a second connecting rod 335. One end of the first connecting rod 334 is eccentrically connected to the first cam 332, and the other end of the first connecting rod 334 is hingedly connected to the cutter 31. One end of the second connecting rod 335 is eccentrically connected to the second cam 333, and the other end of the second connecting rod 335 is hingedly connected to the cutter 31. The transmission shaft 331 is configured to drive the first connecting rod 334 and the second connecting rod 335 to move synchronously through the first cam 332 and the second cam 333, thereby driving the cutter 31 to move.

The first cam 332 and the first connecting rod 334 may be provided on one side of the conveying assembly 2, and the second cam 333 and the second connecting rod 335 may be provided on the other side of the conveying assembly 2. The first connecting rod 334 may be connected to one end of the cutter 31, and the second connecting rod 335 may be connected to the other end of the cutter 31, avoiding interference with the material on the conveying assembly 2. With the above structure, the transmission mechanism 33 can simultaneously transmit a driving force to the two ends of the cutter 31, avoiding a deformation of the cutter 31 caused by the excessive concentration of the stress on the cutter 31.

Specifically, the transmission shaft 331 may be provided transversely below the conveying assembly 2 and perpendicular to an extension direction of the conveying assembly 2, and the transmission shaft 331 may be mounted on the frame body 1 through several shaft seats. The second driving mechanism is in transmission connection with the transmission shaft 331 to drive the transmission shaft 331 to rotate. The second driving mechanism includes a motor, and an output end of the motor may be directly coaxially connected to the transmission shaft 331, or may be in transmission connection with the transmission shaft 331 through a gear, a belt or other components, to which no limitation is made in the present disclosure.

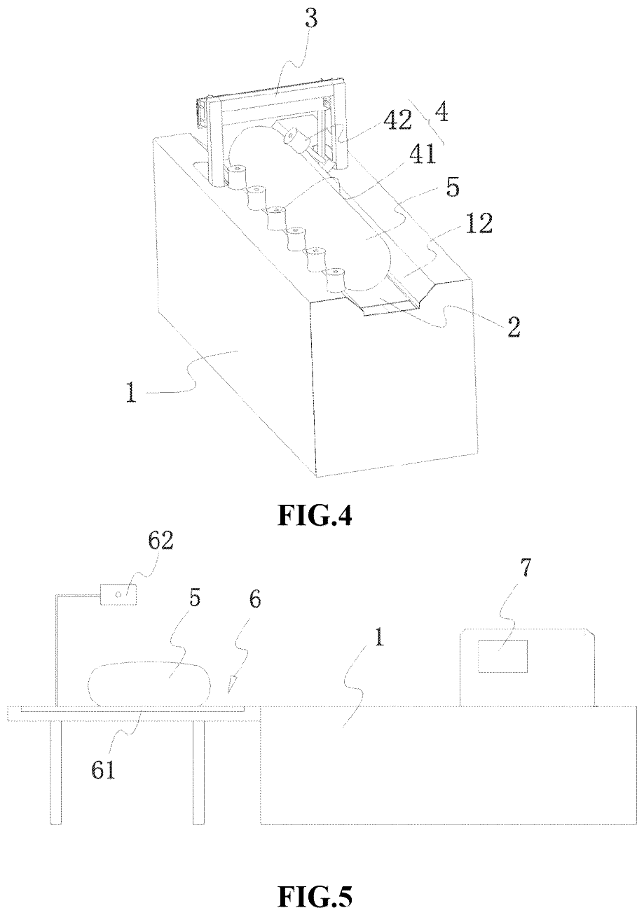

FIG. 4 is a schematic structural diagram of the cutting device with a protective cover removed provided in an embodiment of the present disclosure. In some implementations, as shown in FIG. 4, the frame body 1 is provided with baffles 12, the baffles 12 being provided at the two opposite sides of the conveying assembly 2 and higher than the bearing surface of the conveying assembly 2. The baffles 12 can restrict the material 5 on the conveying assembly 2, preventing the material 5 from falling from the two sides of the conveying assembly 2.

In a specific embodiment, the conveyor belt 24 of the conveying assembly 2 is at least partially exposed from the frame body 1 of the box structure, the baffles 12 on the two sides of the conveying assembly 2 may be inclined and form a flare on the two sides of the conveying assembly, so as to place the material on the conveying assembly 2. Tops of the baffles 12 on the two sides may be folded horizontally in opposite directions to constitute platforms, and holes or slots may be opened on the platforms for the cutter holder 32 and the transmission assembly 33 to protrude upwards.

In some implementations, with reference to FIG. 4, the frame body 1 is further provided with a guide assembly, the guide assembly being configured to be provided along the extension direction of the conveying assembly 2 to guide the material 5 on the conveying assembly 2. The guide assembly may be provided on two opposite sides of or above the conveying assembly 2 and higher than a height of the baffles 12. The guide assembly may include, but is not limited to, a guide rod, a guide plate, a guide roller or other structures, as long as the material on the conveying assembly 2 can be guided.

In an implementation, the guide assembly includes a plurality of guide rollers 4 that may be distributed above or on two sides of the conveying assembly 2. The guide rollers 4 may be provided vertically, transversely, or inclinedly. The guide rollers 4 may be arrayed along the extension direction of the conveying assembly 2, and at least one guide roller 4 is provided on each side of the conveying assembly 2. The plurality of guide rollers 4 may be arrayed from the feeding end 21 to the discharging end 22 of the conveying assembly 2, or may be arranged only in a partial region between the feeding end 21 and the discharging end 22. For example, the guide rollers 4 are only distributed between the feeding end 21 of the conveying assembly and the cutting assembly 3. The guide rollers 4, when in contact with the material, can roll relative to the material, and the generated friction resistance is small.

In an implementation, the two sides of the conveying assembly 2 are both provided with baffles 12 and guide rollers 4, with the guide rollers 4 positioned higher than the baffles 12. Specifically, the guide rollers 4 may be mounted at a top edge of the baffles 12. When a large-sized material, such as a wax gourd, moves on the conveying assembly 2 beyond a range between the baffles 12 on the two sides, rolling friction can be generated between the same and the guide rollers 4, and the resistance caused by the guide rollers 4 to the material is small, so that the material can be smoothly conveyed on the conveying assembly 2.

In some implementations, with reference to FIG. 4, the guide rollers 4 include fixed guide rollers 41 and an inclined guide roller 42. The fixed guide rollers 41 are at least provided on one side of the conveying assembly 2, the fixed guide rollers 41 may be arrayed along the extension direction of the conveying assembly 2, and the fixed guide rollers 41 are all provided vertically, with the positions fixed relative to the frame body 1. The inclined guide roller 42 is provided at least on one side of the conveying assembly 2, and the inclined guide roller 42 is provided inclinedly in such a manner that an upper end is gradually close to the conveying assembly 2, which can be pressed on the material 5 to play a limiting role on the material 5.

The inclined guide roller 42 may be connected to the frame body 1 through a movable structure, and an inclination angle thereof can be adjusted through the movable structure. The movable structure may be a hinged structure, an elastic device, or the like, so as to adapt to materials of different sizes. A position of the inclined guide roller 42 may be defined by a limit structure, and the limit structure may be a locking bolt, a damping device, or the like. After adjusting the angle of the inclined guide roller 42 according to the material and pressing the same against the material, definition is performed through the limit structure, so that the inclined guide roller 42 can be fixed relative to the frame body 1. When the material 5 is cut, shaking may occur under the pressure of the cutter 31, which affects the cutting precision, while the inclined guide roller 42 can effectively define the material 5, thereby improving the cutting precision and reducing the loss. In a preferred embodiment, the position of the inclined guide roller 42 may approach the cutting assembly 3, thereby better playing a defining role.

In a specific embodiment, with reference to FIG. 4, one side of the conveying assembly 2 is arrayed with a plurality of fixed guide rollers 41, and the other side is provided with one inclined guide roller 42. Both the fixed guide rollers 4 and the inclined guide roller 42 are provided between the feeding end 21 of the conveying assembly 2 and the cutting assembly 3, and the inclined guide roller 42 is located close to the cutting assembly 3. Working staff may stand on the side where the inclined guide roller 42 is located, put the material 5 to the conveying assembly 2, and adjust the inclined guide roller 42.

In an implementation, with reference to FIG. 1, a protective cover 13 may be provided on the frame body 1, and the protective cover 13 is at least covered outside the cutting assembly 3. The cutting assembly 3 has a certain level of danger, and the protective cover 13 covered outside the cutting assembly 3 can prevent working staff from directly contacting the cutting assembly 3 and improve the safety. In addition, the protective cover 13 should leave an opening for the material 5 to enter and exit.

### Second Embodiment

The difference between this embodiment and the first embodiment lies in that the cutting device further includes a control system, the control system being configured to control on/off and movement speeds of the conveying assembly 2 and the cutting assembly 3. The repeated part will not be repeated here.

When the material is a fresh product, a shape of the material is mostly irregular, such as wax gourd, radish, corn, or the like. When strokes of the conveying assembly 2 and the cutting assembly 3 are given, single finished products cut from the material are uniform in length, but not in weight. In this regard, a preset algorithm may be set in the control system to adjust a relative movement speed of the conveying assembly 2 and the cutting assembly 3.

Specifically, the control system may send a control signal to the motor of the first driving mechanism and the motor of the second driving mechanism respectively, to control on/off and rotation speeds of the motors, thereby controlling the on/off and movement speeds of the conveying assembly 2 and the cutting assembly 3. By adjusting and controlling the relative movement speed between the conveying assembly 2 and the cutting assembly 3, a length of the material 5 that is cut can be controlled.

In an implementation, as shown in FIG. 5, the cutting device further includes a weighing unit 61 and a measuring unit 62. The weighing unit 61 is configured to acquire weight data T of the material 5; and the measuring unit 62 is configured to at least acquire length data L of the material 5. The weighing unit 61 and the measuring unit 62 can send the weight data T and length data L obtained to the control system.

In an implementation, the measuring unit 62 can detect profile data of the material 5, including the length data L of the material and radial dimension data of each part of the material. Since fresh products such as wax gourd usually have an irregular shape, difference exists in the radial dimension data of each part of the material obtained by the measuring unit 62.

The weighing unit may be a pressure sensor or the like, and the measuring unit may employ a three-dimensional imaging module, for example, a camera device such as a depth camera or a panoramic camera. Other types of regular devices for measuring data such as material weight, length, profile or the like that can be envisaged by those skilled in the art are all included in the scope of protection of the present disclosure.

The cutting device may include an information collection position 6. The information collection position 6 may be provided with a platform for placing a material. The weighing unit 61 and the measuring unit 62 are provided at the information collection position 6, with the weighing unit 61 capable of acquiring weight data T of the material placed on the platform at the information collection position, and the measuring unit 62 at least capable of acquiring length data L of the material placed at the information collection position.

The information collection position 6 may be provided together with or separate from the frame body 1. When working, the material 5 is first placed on the information collection position 6, the weight data T and the length data L of the material are acquired by the weighing unit and the measuring unit, and then the material 5 is transferred to the feeding end 21 of the conveying assembly 2.

In an implementation, as shown in FIG. 5, the information collection position 6 is provided together with the frame body 1. The platform at the information collection position 6 is provided at the feeding end 21 of the conveying assembly 2 and is flush with the bearing surface of the conveying assembly 2. After the weight data T and the length data L of the material 5 are acquired on the information collection position 6 by the weighing unit 61 and the measuring unit 62, the material 5 may be directly pushed to the feeding end 21 of the conveying assembly 2. Further, the platform at the information collection position 6 may be provided with a transporting device, such as an electrically actuated transporting roller, transporting belt, and the like, which can replace manpower to directly convey the material 5 on the platform to the feeding end 21 of the flush conveying assembly 2, and is more convenient to use.

In detail, the weighing unit 61 may employ a pressure sensor, and is provided on the platform of the information collection position 6. After the material is placed on the platform, the pressure sensor can detect the pressure generated by the material on the platform, thereby generating the weight data T of the material. The measuring unit 62 may employ a camera device, and is provided above or on a side of the information collection position, and can scan the material placed on the platform of the information collection position to acquire the length data L of the material. Specifically, the measuring unit 62 may be supported above the information collection position by a bracket connected to the platform or the frame body 1.

The control system has a preset algorithm, and the control system is configured to: perform calculation according to a preset algorithm based on the weight data T, the length data L, a preset single target standard weight T′ of the material, and a preset correction factor, to obtain a single target length L′; and then adjust, based on the single target length L′, a relative movement speed of the conveying assembly 2 and the cutting assembly 3 to precisely cut the material with an irregular contour into single finished products having a length of the single target length L′ and a uniform weight.

In an implementation, as shown in FIG. 5, the cutting device further includes a control panel 7. The control panel 7 may employ a display screen and a control button, or the control panel may directly employ a touch pad. The control panel 7 is electrically or communicatively connected to the control system. The control panel 7 is provided with control buttons such as On, Off and Pause, and the control panel 7 can display data representing working states of the conveying assembly 2 and the cutting assembly 3, such as an alternating current frequency and output power of the first driving mechanism and the second driving mechanism, an actual length of a finished product cut by the cutting assembly 3 each time, and the like. Through the control panel 7, a single target standard weight T′, a correction factor and other parameters of the material may be preset for the control system.

The control system and the control panel may be integrated on the frame body 1 of the cutting device, or may also be provided separately to implement remote control of the cutting device.

An alarm unit may also be provided on the cutting device, and the alarm device may be provided to detect working states of the motor of the first driving mechanism and the motor of the second driving mechanism. When it is detected that a working state reaches an alarm preset value, the alarm device is triggered. After the alarm device is triggered, it can give an alarm by employing such ways as emitting a prompt sound, and lighting a warning lamp, or may also display an abnormal situation on the control panel 7. A control button for turning off the alarm unit may be provided on the control panel 7.

The control system can be set to operate in two control modes, i.e., an automatic mode and a manual mode. In the automatic mode, the control system performs calculation according to the preset algorithm, obtains the single target length L′ for cutting the material, and then automatically adjusts, based on the single target length L′, the relative movement speed of the conveying assembly 2 and the cutting assembly 3 to cut the material into a finished product having a length of the single target length L′. In the manual mode, the working staff may autonomously adjust the relative movement speed of the conveying assembly 2 and the cutting assembly 3 through the control panel 7 to cut the material into any length. The manual mode can make up for the shortcomings of the automatic mode in terms of flexibility and controllability, making the function of the cutting device more improved.

### Third Embodiment

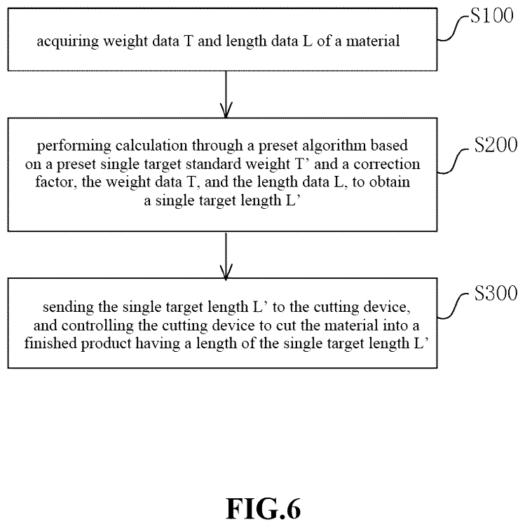

The present disclosure further provides a cutting method applied to the above cutting device, as shown in FIG. 6, including:

At S100, acquiring weight data T and length data L of a material.

When working, the material is placed on the information collection position, the weighing unit and the measuring unit can detect the material on the information collection position, acquire the weight data T and the length data L of the material, and can send the weight data T and the length data L obtained to the control system. After the data is collected, the material is conveyed from the information collection position to the feeding end of the conveying assembly.

At S200, performing calculation through a preset algorithm based on a preset single target standard weight T′ and a correction factor, the weight data T, and the length data L, to obtain a single target length L′.

The single target standard weight T′ and the correction factor are preset for the control system through the control panel. The single target standard weight T′ is a weight of a single finished product obtained by cutting the material, and the correction factor is used for correcting an error caused by factors such as length loss of the material in a cutting process or irregularity of the material contour, improving the calculation precision of the preset algorithm.

Specifically, the correction factor includes a quantity correction factor X, the quantity correction factor X being a quantity of finished products that allows for loss of the material. The preset algorithm includes the following steps.

Determining a weight ratio based on a preset single target standard weight T′ and the weight data T. The weight ratio may be a ratio of the weight data T to the single target standard weight T′.

Determining a correction difference based on the weight ratio and the quantity correction factor X. The correction difference may be a difference of the weight ratio minus the quantity correction factor X.

Obtaining a single target length L′ based on the correction difference and the length data L. The single target length L′ may be a ratio of the length data L to the correction difference.

When the material is cut into several finished products according to the required preset single target standard weight T′, there will be certain loss. For example, if the weight data T of the material is 14 kg, the required preset single target standard weight T′ is 500 g, and each finished product, only when processed to have a weight greater than or equal to 500 g, can be regarded as a finished product, then 28 finished products can be yielded theoretically. However, due to precision error, loss will occur in an actual cutting process, so that some finished products may weigh more than 500 g, while some finished products may weigh less than 500 g and become waste products. Therefore, in determining the quantity of finished products yielded, X parts may be reduced, and the quantity correction factor X is the quantity of finished products subtracted to allow for loss, reducing waste products having a weight less than 500 g.

At S300: sending the single target length L′ to the cutting device, and controlling the cutting device to cut the material into a finished product having a length of the single target length L′.

The control system can adjust the relative movement speed of the conveying assembly and the cutting assembly by controlling the first driving mechanism of the conveying assembly and/or the second driving mechanism of the cutting assembly, and a movement stroke of the conveying assembly is the single target length L′ within an interval time of the cutting action of the cutting assembly, so that the cutting assembly cuts, based on the relative operation speed, the material into the finished product having a length of the single target length L′.

In the cutting method of this embodiment, the control system calculates the single target length L′ through the preset algorithm based on the preset single target standard weight T′ and the quantity correction factor X, the weight data T, and the length data L of the material, and the cutting device adjusts the relative movement speed of the conveying assembly and the cutting assembly to cut the material into a finished product having the single target length L′, a weight of each finished product as cut being the single target standard weight T′. Compared with the current manual cutting method, the cutting method of the present disclosure effectively saves human labor and improves the precision of the weight of a finished product.

### Fourth Embodiment

The present disclosure further provides a cutting method applied to the above cutting device. Different from the method disclosed in the third embodiment, the method of this embodiment further includes: obtaining profile data of a material, the profile data including length data L of the material and radial dimension data of the material.

The measuring unit of the cutting device is a camera device capable of acquiring overall profile data of the material and sending the profile data to the control system. The profile data includes the length data L of the material and radial dimension data of each part of the material.

In this embodiment, the correction factor includes a quantity correction factor X and a length correction factor Y, the quantity correction factor X being the quantity of finished products subtracted for allowing for cutting loss, and the length correction factor Y being used for correcting an error caused by the contour irregularity of the material.

In this embodiment, the preset algorithm at step S200 includes following steps.

Determining a weight ratio based on a preset single target standard weight T′ and the weight data T. The weight ratio may be a ratio of the weight data T to the single target standard weight T′.

Determining a correction difference based on the weight ratio and the quantity correction factor X. The correction difference may be a difference of the weight ratio minus the quantity correction factor X.

Determining a correction ratio based on the correction difference and the length data L. The correction ratio may be a ratio of the length data L to the correction difference.

Obtaining a single target length L′ based on the correction ratio and the length correction factor Y. The single target length L′ may be a difference of the correction ratio minus the length correction factor Y.

The value of Y may be set as a range value or a plurality of numerical values, which may be obtained by precise calculation of the material volume, or may be determined by accumulation of a certain amount of actual data. Moreover, the length correction factor Y is set to be negatively correlated with a radial dimension of the profile data of the material.

For example, by setting the length correction factor Y to 0, 0.5, and 1, the control system may adjust the value of Y according to the radial dimension data of the material. When a part of the material moved to the cutting assembly has a radial dimension between 60 cm-55 cm, the value of Y is adjusted to 0; when a part of the material moved to the cutting assembly has a radial dimension between 55 cm-50 cm, the value of Y is adjusted to 0.5; and when a part of the material moved to the cutting assembly has a radial dimension between 50 cm-45 cm, the value of Y is adjusted to 1. The smaller a radial dimension of a cut part of the material, the greater the value of Y needs to be adjusted, so as to increase the calculated single target length L′, make up for the volume of the cut finished product, and implement the precise cutting of the material into a single finished product with uniform weight.

In the cutting method of this embodiment, the length correction factor Y is set in the preset formula, which effectively corrects the error caused by the contour irregularity of the material, so that the cutting device can more precisely cut out a single finished product with uniform weight, and improve the working yield.

In an application scenario, a wax gourd is cut into multiple finished products by the cutting device. The shape of two ends of the wax gourd is irregular, and finished products cut out at its two ends have a large error. Therefore, irregularities at the two ends of the wax gourd may be cut off manually prior to processing, and then the rest is put into the cutting device.

During operation, the wax gourd with the two ends removed is placed on the information collection position, the weight data T and profile data of the material are detected by the weighing unit and the measuring unit, and the single target standard weight T′, the quantity correction factor X and the length correction factor Y are preset for the control system through the control panel.

Then the wax gourd is conveyed to the feeding end 22 of the conveying assembly 2 in a posture as shown in FIG. 1. The control system performs calculation according to the preset formula based on the weight data T, the length data L in the profile data, the quantity correction factor X and the length correction factor Y to obtain the single target length L′ of the cut wax gourd, and then adjusts the relative movement speed of the conveying assembly 2 and the cutting assembly 3 based on the single target length L′.

The wax gourd is conveyed by the conveying assembly 2 to a direction of the cutting assembly 3, and cut off by the cutter 31 when passing through the cutting assembly 3. The cutting assembly 3 can cut the wax gourd into several finished products having a length of the single target length L′, a weight of each finished product being the single target standard weight T′.

The cutting device of the present disclosure can replace manpower to process materials, and can cut materials with an irregular contour into finished products with uniform weight, alleviating human labor, improving working efficiency, effectively reducing the amount of loss, and improving a yield of the materials.

Various embodiments of the present disclosure have been described above. The foregoing description is exemplary, not exhaustive, and is not limited to the disclosed embodiments. Many modifications and variations will be apparent to those of ordinary skill in the art without departing from the scope and spirit of the illustrated embodiments. The terms used herein are chosen to best explain the principles of the embodiments, their practical application, or improvements to the technologies in the market, or to enable others of ordinary skill in the art to understand the embodiments disclosed herein. The scope of the present disclosure is defined by the claims appended thereto.

1. A cutting device, comprising a frame body (1), wherein the frame body (1) is provided with:
a conveying assembly (2), the conveying assembly (2) comprising a feeding end (21), a discharging end (22), and an avoidance position (23) provided between the feeding end (21) and the discharging end (22), and the conveying assembly (2) being constructed to convey a material (5) from the feeding end (21) to the discharging end (22); and
a cutting assembly (3), the cutting assembly (3) comprising a cutter (31), and the cutter (31) being constructed to be capable of moving towards the conveying assembly (2) to the avoidance position (23).

2. The cutting device according to claim 1, wherein the conveying assembly (2) comprises a bearing surface for bearing the material (5), and the avoidance position (23) is constructed as a groove-shaped structure lower than the bearing surface; and
the conveying assembly (2) further comprises:
a conveyor belt (24), the conveyor belt (24) being bent to form the avoidance position (23);
a first limit roller (25), the first limit roller (25) being provided on both sides of an opening of the avoidance position (23) and located on an inner side of the conveyor belt (24); and
a second limit roller (26), the second limit roller (26) being provided at a groove bottom of the avoidance position (23) and located on an outer side of the conveyor belt (24).

3. The cutting device according to claim 1, wherein the cutting assembly (3) further comprises a cutter holder (32) connected to the frame body (1), and the cutter (31) being guided to fit on the cutter holder (32); and
the cutting assembly (3) further comprises a transmission mechanism (33) and a second driving mechanism, the second driving mechanism driving the cutter (31) to move through the transmission mechanism (33).

4. The cutting device according to claim 3, wherein the transmission mechanism (33) comprises: a transmission shaft (331), a first cam (332) and a second cam (333) fixedly connected to two ends of the transmission shaft (331) respectively, and further comprises a first connecting rod (334) and a second connecting rod (335);
one end of the first connecting rod (334) being connected to the first cam (332), and the other end of the first connecting rod (334) being connected to the cutter (31);
one end of the second connecting rod (335) being connected to the second cam (333), and the other end of the second connecting rod (335) being connected to the cutter (31); and
the transmission shaft (331) being configured to drive the first connecting rod (334) and the second connecting rod (335) to move synchronously through the first cam (332) and the second cam (333), thereby driving the cutter (31) to move.

5. The cutting device according to claim 4, wherein the cutting device further comprises:
a weighing unit (61), the weighing unit (61) being configured to acquire weight data T of the material (5); and
a measuring unit (62), the measuring unit (62) being configured to at least acquire length data L of the material (5).

6. The cutting device according to claim 5, further comprising a control system, the control system being configured to: perform calculation according to a preset algorithm based on the weight data T, the length data L, and a single target standard weight T′ and a correction factor preset for the material, to obtain a single target length L′ for cutting the material, and adjust, based on the single target length L′, a relative movement speed of the conveying assembly and the cutting assembly.

7. A cutting method, employing the cutting device of claim 1, comprising:
acquiring weight data T and length data L of a material;
performing calculation through a preset algorithm based on a preset single target standard weight T′ and a correction factor, the weight data T, and the length data L, to obtain a single target length L′; and
sending the single target length L′ to the cutting device, and controlling the cutting device to cut the material into a finished product having a length of the single target length L′.

8. The cutting method according to claim 7, wherein the correction factor comprises a quantity correction factor X, the quantity correction factor X being a quantity of finished products that allows for loss of the material; and
the performing calculation through a preset algorithm based on a preset single target standard weight T′ and a correction factor, the weight data T, and the length data L, to obtain a single target length L′ comprises:
determining a weight ratio based on the preset single target standard weight T′ and the weight data T;
determining a correction difference based on the weight ratio and the quantity correction factor X; and
obtaining the single target length L′ based on the correction difference and the length data L.

9. The cutting method according to claim 7, further comprising:
obtaining profile data of the material, the profile data comprising radial dimension data of the material.

10. The cutting method according to claim 9, wherein the correction factor comprises a quantity correction factor X and a length correction factor Y, the quantity correction factor X being a quantity of finished products that allows for loss of the material, and the length correction factor Y being negatively correlated with a radial dimension of the profile data of the material; and
correspondingly, the performing calculation through a preset algorithm based on a preset single target standard weight T′ and a correction factor, the weight data T, and the length data L, to obtain a single target length L′ comprises:
determining a weight ratio based on the preset single target standard weight T′ and the weight data T;
determining a correction difference based on the weight ratio and the quantity correction factor X;
determining a correction ratio based on the correction difference and the length data L; and
obtaining a single target length L′ based on the correction ratio and the length correction factor Y.

11. The cutting device according to claim 2, wherein the cutting assembly (3) further comprises a cutter holder (32) connected to the frame body (1), and the cutter (31) being guided to fit on the cutter holder (32); and
the cutting assembly (3) further comprises a transmission mechanism (33) and a second driving mechanism, the second driving mechanism driving the cutter (31) to move through the transmission mechanism (33).

12. The cutting device according to claim 11, wherein the transmission mechanism (33) comprises: a transmission shaft (331), a first cam (332) and a second cam (333) fixedly connected to two ends of the transmission shaft (331) respectively, and further comprises a first connecting rod (334) and a second connecting rod (335);
one end of the first connecting rod (334) being connected to the first cam (332), and the other end of the first connecting rod (334) being connected to the cutter (31);
one end of the second connecting rod (335) being connected to the second cam (333), and the other end of the second connecting rod (335) being connected to the cutter (31); and
the transmission shaft (331) being configured to drive the first connecting rod (334) and the second connecting rod (335) to move synchronously through the first cam (332) and the second cam (333), thereby driving the cutter (31) to move.

13. The cutting device according to claim 12, wherein the cutting device further comprises:
a weighing unit (61), the weighing unit (61) being configured to acquire weight data T of the material (5); and
a measuring unit (62), the measuring unit (62) being configured to at least acquire length data L of the material (5).

14. The cutting device according to claim 13, further comprising a control system, the control system being configured to: perform calculation according to a preset algorithm based on the weight data T, the length data L, and a single target standard weight T′ and a correction factor preset for the material, to obtain a single target length L′ for cutting the material, and adjust, based on the single target length L′, a relative movement speed of the conveying assembly and the cutting assembly.

15. A cutting method, employing the cutting device of claim 2, comprising:
acquiring weight data T and length data L of a material;
performing calculation through a preset algorithm based on a preset single target standard weight T′ and a correction factor, the weight data T, and the length data L, to obtain a single target length L′; and
sending the single target length L′ to the cutting device, and controlling the cutting device to cut the material into a finished product having a length of the single target length L′.

16. The cutting method according to claim 15, wherein the correction factor comprises a quantity correction factor X, the quantity correction factor X being a quantity of finished products that allows for loss of the material; and
the performing calculation through a preset algorithm based on a preset single target standard weight T′ and a correction factor, the weight data T, and the length data L, to obtain a single target length L′ comprises:
determining a weight ratio based on the preset single target standard weight T′ and the weight data T;
determining a correction difference based on the weight ratio and the quantity correction factor X; and
obtaining the single target length L′ based on the correction difference and the length data L.

17. The cutting method according to claim 15, further comprising:
obtaining profile data of the material, the profile data comprising radial dimension data of the material.

18. The cutting method according to claim 17, wherein the correction factor comprises a quantity correction factor X and a length correction factor Y, the quantity correction factor X being a quantity of finished products that allows for loss of the material, and the length correction factor Y being negatively correlated with a radial dimension of the profile data of the material; and
correspondingly, the performing calculation through a preset algorithm based on a preset single target standard weight T′ and a correction factor, the weight data T, and the length data L, to obtain a single target length L′ comprises:
determining a weight ratio based on the preset single target standard weight T′ and the weight data T;
determining a correction difference based on the weight ratio and the quantity correction factor X;
determining a correction ratio based on the correction difference and the length data L; and
obtaining a single target length L′ based on the correction ratio and the length correction factor Y.

19. A cutting method, employing the cutting device of claim 3, comprising:
acquiring weight data T and length data L of a material;
performing calculation through a preset algorithm based on a preset single target standard weight T′ and a correction factor, the weight data T, and the length data L, to obtain a single target length L′; and
sending the single target length L′ to the cutting device, and controlling the cutting device to cut the material into a finished product having a length of the single target length L′.

20. The cutting method according to claim 19, wherein the correction factor comprises a quantity correction factor X, the quantity correction factor X being a quantity of finished products that allows for loss of the material; and
the performing calculation through a preset algorithm based on a preset single target standard weight T′ and a correction factor, the weight data T, and the length data L, to obtain a single target length L′ comprises:
determining a weight ratio based on the preset single target standard weight T′ and the weight data T;
determining a correction difference based on the weight ratio and the quantity correction factor X; and
obtaining the single target length L′ based on the correction difference and the length data L.
